(19) United States
(12) Patent Application Publication
(10) Pub. No.: US 2024/0349290 A1
(43) Pub. Date: Oct. 17, 2024

(54) METHOD FOR TRANSMITTING OR RECEIVING DOWNLINK CONTROL CHANNEL AND DEVICE THEREFOR

(71) Applicant: LG ELECTRONICS INC., Seoul (KR)

(72) Inventors: Sunghoon LEE, Seoul (KR); Seonwook KIM, Seoul (KR); Seunggye HWANG, Seoul (KR); Youngdae LEE, Seoul (KR); Suckchel YANG, Seoul (KR)

(73) Assignee: LG ELECTRONICS INC., Seoul (KR)

(21) Appl. No.: 18/294,495

(22) PCT Filed: Jul. 25, 2022
(86) PCT No.: PCT/KR2022/010897

§ 371 Date: Feb. 1, 2024

(30) Foreign Application Priority Data
Aug. 6, 2021 (KR) 10-2021-0103905

(51) Int. Cl. H04W 72/23; H04L 5/00

(52) U.S. Cl. CPC H04W 72/23; H04L 5/0094

(57) ABSTRACT

The present disclosure provides a method by which a terminal receives a physical downlink control channel (PDCCH) in a wireless communication system. In particular, the method comprises: receiving a parameter related to PDCCH monitoring adaptation through a higher layer; receiving information indicating an operation related to the PDCCH monitoring adaptation, on the basis of the parameter; and receiving the PDCCH on the basis of the information, wherein the receiving of the PDCCH comprises monitoring the PDCCH through a common search space (CSS) set on the basis of an RNTI different from a radio network temporary identifier (C-RNTI) during a time interval associated with the information.

### TECHNICAL FIELD

The present disclosure relates to a method of transmitting and receiving a downlink control channel and an apparatus therefor, and more particularly, to a method of monitoring a physical downlink control channel (PDCCH) based on PDCCH monitoring adaptation for a Type0/0A/1/2-PDCCH common search space (CSS) set and an apparatus therefor.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

An object of the present disclosure is to provide a method of transmitting and receiving a downlink control channel and an apparatus therefor.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to an aspect of the present disclosure, provided herein is a method of receiving a physical downlink control channel (PDCCH) by a user equipment (UE) in a wireless communication system, including receiving a parameter related to PDCCH monitoring adaptation through a higher layer, receiving information regarding an operation related to the PDCCH monitoring adaptation based on the parameter, and receiving the PDCCH based on the information. The receiving the PDCCH may include monitoring the PDCCH through a common search space (CSS) set based on a radio network temporary identifier (RNTI) different from a cell-RNTI (C-RNTI) during a time duration related to the information.

The method may include monitoring the PDCCH through the CSS set based on the C-RNTI, based on reception of the PDCCH through the CSS set based on the RNTI.

The method may further include receiving information related to a time for monitoring the PDCCH based on the C-RNTI, and monitoring the PDCCH based on the C-RNTI through the CSS set based on the information related to the time.

The method may further include monitoring the PDCCH based on the C-RNTI for a type of a CSS set included in a specific search space (SS) set, based on the PDCCH monitoring adaptation being related to SS set switching regarding switching to the specific SS set.

The CSS set may have a type different from Type 2.

The PDCCH may be monitored by prioritizing a UE-specific search space (USS) over a CSS during the time duration.

The CSS set may have a type different from Type 3.

In another aspect of the present disclosure, provided herein is a user equipment (UE) for receiving a physical downlink control channel (PDCCH) in a wireless communication system, including at least one transceiver; at least one processor; and at least one memory operably connectable to the at least one processor and configured to store instructions that, when executed, cause the at least one processor to perform operations. The operations may include receiving, through the at least one transceiver, a parameter related to PDCCH monitoring adaptation through a higher layer, receiving, through the at least one transceiver, information regarding an operation related to the PDCCH monitoring adaptation based on the parameter, and receiving, through the at least one transceiver, the PDCCH based on the information. The receiving the PDCCH may include monitoring the PDCCH through a common search space (CSS) set based on a radio network temporary identifier (RNTI) different from a cell-RNTI (C-RNTI) during a time duration related to the information.

The operations may include monitoring the PDCCH through the CSS set based on the C-RNTI, based on reception of the PDCCH through the CSS set based on the RNTI.

The operations may further include receiving information related to a time for monitoring the PDCCH based on the C-RNTI, and monitoring the PDCCH based on the C-RNTI through the CSS set based on the information related to the time.

The operations may further include monitoring the PDCCH based on the C-RNTI for a type of a CSS set included in a specific search space (SS) set, based on the PDCCH monitoring adaptation being related to SS set switching regarding switching to the specific SS set.

The CSS set may have a type different from Type 2.

The PDCCH may be monitored by prioritizing a UE-specific search space (USS) over a CSS during the time duration.

The CSS set may have a type different from Type 3.

In another aspect of the present disclosure, provided herein is an apparatus for receiving a physical downlink control channel (PDCCH) in a wireless communication system, including at least one processor; and at least one memory operably connectable to the at least one processor and configured to store instructions that, when executed, cause the at least one processor to perform operations. The operations may include receiving a parameter related to PDCCH monitoring adaptation through a higher layer, receiving information regarding an operation related to the PDCCH monitoring adaptation based on the parameter, and receiving the PDCCH based on the information. The receiving the PDCCH may include monitoring the PDCCH through a common search space (CSS) set based on a radio network temporary identifier (RNTI) different from a cell-RNTI (C-RNTI) during a time duration related to the information.

In another aspect of the present disclosure, provided herein is a computer-readable storage medium including at least one computer program that causes at least one processor to perform operations. The operations may include receiving a parameter related to PDCCH monitoring adaptation through a higher layer, receiving information regarding an operation related to the PDCCH monitoring adaptation based on the parameter, and receiving the PDCCH based on the information. The receiving the PDCCH may include monitoring the PDCCH through a common search space (CSS) set based on a radio network temporary identifier (RNTI) different from a cell-RNTI (C-RNTI) during a time duration related to the information.

In another aspect of the present disclosure, provided herein is a method of transmitting a physical downlink control channel (PDCCH) by a base station (BS) in a wireless communication system, including transmitting a parameter related to PDCCH monitoring adaptation through a higher layer, transmitting information regarding an operation related to the PDCCH monitoring adaptation based on the parameter, and transmitting the PDCCH through a common search space (CSS) set based on a radio network temporary identifier (RNTI) different from a cell-RNTI (C-RNTI) during a time duration related to the information.

In another aspect of the present disclosure, provided herein is a base station (BS) for transmitting a physical downlink control channel (PDCCH) in a wireless communication system, including at least one transceiver; at least one processor; and at least one memory operably connectable to the at least one processor and configured to store instructions that, when executed, cause the at least one processor to perform operations. The operations may include transmitting, through the at least one transceiver, a parameter related to PDCCH monitoring adaptation through a higher layer, transmitting, through the at least one transceiver, information regarding an operation related to the PDCCH monitoring adaptation based on the parameter, and transmitting, through the at least one transceiver, the PDCCH through a common search space (CSS) set based on a radio network temporary identifier (RNTI) different from a cell-RNTI (C-RNTI) during a time duration related to the information.

According to the present disclosure, when a UE monitors a PDCCH, power consumption may be reduced.

In particular, according to [Method #1] and/or [Method #2] of the present disclosure, even when the UE performs PDCCH monitoring for a Type0/0A/1/2-PDCCH CSS set, power consumption is reduced by performing PDCCH monitoring adaptation.

In addition, according to [Method #3] of the present disclosure, monitoring of only a CSS set and dropping of monitoring of a USS set, due to the limited number of times of PDCCH monitoring, may be prevented.

It is to be understood that both the foregoing general description and the following detailed description of the present disclosure are exemplary and explanatory and are intended to provide further explanation of the disclosure as claimed.

### BRIEF DESCRIPTION OF DRAWINGS

FIGS. 1 and 2 are diagrams for explaining idle mode discontinuous reception (DRX) operation;

FIGS. 3 to 5 are diagrams for explaining DRX operation in a radio resource control (RRC) connected mode;

FIG. 6 is a diagram for explaining a method of monitoring DCI format 2_6;

FIGS. 7 to 9 are diagrams for explaining the overall operation processes of a UE and a BS according to an embodiment of the present disclosure;

FIG. 10 illustrates an exemplary communication system applied to the present disclosure;

FIG. 11 illustrates an exemplary wireless device applicable to the present disclosure;

FIG. 12 illustrates an exemplary vehicle or autonomous driving vehicle applicable to the present disclosure; and

FIG. 13 illustrates an extended reality (XR) device applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost-and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

### DL Channel Structures

An eNB transmits related signals on later-described DL channels to a UE, and the UE receives the related signals on the DL channels from the eNB.

### (1) Physical Downlink Shared Channel (PDSCH)

The PDSCH carries DL data (e.g., a DL-shared channel transport block (DL-SCH TB)) and adopts a modulation scheme such as quadrature phase shift keying (QPSK), 16-ary quadrature amplitude modulation (16 QAM), 64-ary QAM (64 QAM), or 256-ary QAM (256 QAM). A TB is encoded to a codeword. The PDSCH may deliver up to two codewords. The codewords are individually subjected to scrambling and modulation mapping, and modulation symbols from each codeword are mapped to one or more layers. An OFDM signal is generated by mapping each layer together with a DMRS to resources, and transmitted through a corresponding antenna port.

### (2) Physical Downlink Control Channel (PDCCH)

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH uses a fixed modulation scheme (e.g., QPSK). One PDCCH includes 1, 2, 4, 8, or 16 control channel elements (CCEs) according to its aggregation level (AL). One CCE includes 6 resource element groups (REGs), each REG being defined by one OFDM symbol by one (P)RB.

To receive the PDCCH, the UE may monitor (e.g., blind-decode) a set of PDCCH candidates in the CORESET. The PDCCH candidates are CCE(s) that the UE monitors for PDCCH reception/detection. The PDCCH monitoring may be performed in one or more CORESETs in an active DL BWP on each active cell configured with PDCCH monitoring. A set of PDCCH candidates monitored by the UE is defined as a PDCCH search space (SS) set. The SS set may be a common search space (CSS) set or a UE-specific search space (USS) set.

Table 1 lists exemplary PDCCH SSs.

TABLE 1

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, | |
| | | C-RNTI, MCS-C-RNTI, | |
| | | or CS-RNTI(s) | |
| UE | UE | C-RNTI, or MCS-C-RNTI, or | User specific |
| Specific | Specific | CS-RNTI(s) | PDSCH |
| | | | decoding |

The SS set may be configured by system information (e.g., MIB) or UE-specific higher-layer (e.g., RRC) signaling. S or fewer SS sets may be configured in each DL BWP of a serving cell. For example, the following parameters/information may be provided for each SS set. Each SS set may be associated with one CORESET, and each CORESET configuration may be associated with one or more SS sets.-searchSpaceId: indicates the ID of the SS set.
controlResourceSetId: indicates a CORESET associated with the SS set.
monitoringSlotPeriodicityAndOffset: indicates a PDCCH monitoring periodicity (in slots) and a PDCCH monitoring offset (in slots).
monitoringSymbolsWithinSlot: indicates the first OFDMA symbol(s) for PDCCH monitoring in a slot configured with PDCCH monitoring. The OFDMA symbols are indicated by a bitmap and each bit of the bitmap corresponds to one OFDM symbol in the slot. The MSB of the bitmap corresponds to the first OFDM symbol of the slot. OFDMA symbol(s) corresponding to bit(s) set to 1 corresponds to the first symbol(s) of the CORESET in the slot.
nrofCandidates: indicates the number of PDCCH candidates (e.g., one of 0, 1, 2, 3, 4, 5, 6, and 8) for each AL={1, 2, 4, 8, 16}.
searchSpaceType: indicates whether the SS type is CSS or USS.
DCI format: indicates the DCI format of PDCCH candidates.

The UE may monitor PDCCH candidates in one or more SS sets in a slot based on a CORESET/SS set configuration. An occasion (e.g., time/frequency resources) in which the PDCCH candidates should be monitored is defined as a PDCCH (monitoring) occasion. One or more PDCCH (monitoring) occasions may be configured in a slot.

Table 2 illustrates exemplary DCI formats transmitted on the PDCCH.

TABLE 2

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs. DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

### DRX (Discontinuous Reception) Operation

The UE uses Discontinuous Reception (DRX) in RRC_IDLE and RRC_INACTIVE state in order to reduce power consumption. When the DRX is configured, the UE performs a DRX operation according to DRX configuration information.

When the UE operates based on the DRX, the UE repeats ON/OFF for reception. For example, when the DRX is configured, the UE attempts to receive/detect the PDCCH (e.g., PDCCH monitoring) only in a predetermined time interval (e.g., ON), and does not attempt to receive the PDCCH in the remaining time period (e.g., OFF/sleep).

At this time, a time period during which the UE should attempt to receive the PDCCH is referred to as an On-duration, and this on-duration is defined once per DRX cycle. The UE can receive DRX configuration information from a gNB through a RRC signaling and operate as the DRX through a reception of the (Long) DRX command MAC CE.

The DRX configuration information may be included in the MAC-CellGroupConfig. The IE MAC-CellGroupConfig is used to configure MAC parameters for a cell group, including DRX.

DRX (Discontinuous Reception) means an operation mode for enabling a UE (User Equipment) to reduce battery consumption so that the UE can receive/monitor a downlink channel discontiguously. That is, a UE configured with DRX can reduce power consumption by receiving a DL signal discontiguously. The DRX operation is performed in a DRX cycle indicative of a time interval in which On Duration is periodically repeated. The DRX cycle includes On Duration and sleep duration (or Opportunity for DRX). The On Duration indicates a time interval in which a UE monitors a PDCCH in order to receive the PDCCH. DRX may be performed in an RRC (Radio Resource Control)_IDLE state (or mode), an RRC_INACTIVE state (or mode), or an RRC_CONNECTED state (or mode). In the RRC_IDLE state and the RRC_INACTIVE state, DRX is used to receive a paging signal discontiguously.
RRC_Idle state: state in which a radio connection (RRC connection) is not established between a base station and a UE.
RRC Inactive state: state in which a radio connection (RRC connection) has been established between a base station and a UE, but a radio connection is inactivated.
RRC_Connected state: state in which a radio connection (RRC connection) has been established between a base station and a UE.

DRX is basically divided into Idle mode DRX, Connected DRX (C-DRX) and extended DRX. DRX applied in the RRC IDLE state is called Idle mode DRX, and DRX applied in the RRC CONNECTED state is called Connected mode DRX (C-DRX).

eDRX (Extended/enhanced DRX) is a mechanism capable of expanding the cycle of Idle mode DRX and C-DRX. In the Idle mode DRX, whether to permit eDRX may be configured based on system information (e.g., SIB1).

The SIB1 may include an eDRX-Allowed parameter. The eDRX-Allowed parameter is a parameter indicating whether Idle mode extended DRX is permitted.

### (1) IDLE Mode DRX

In the IDLE mode, the UE may use DRX to reduce power consumption. One paging occasion (PO) may be a time interval (e.g., a slot or a subframe) in which a paging-radio network temporary identifier (P-RNTI) based physical downlink control channel (PDCCH) may be transmitted. The P-RNTI-based PDCCH may address/schedule a paging message. For P-RNTI-based PDCCH transmission, the PO may indicate a first subframe for PDCCH repetition.

One paging frame (PF) is one radio frame which may include one or a plurality of paging occasions. When DRX is used, a UE may be configured to monitor only one PO per DRX cycle. The PF, PO and/or PNB may be determined based on a DRX parameter provided via network signaling (e.g., system information).

Hereafter, ‘PDCCH’ may refer to MPDCCH, NPDCCH and/or normal PDCCH. Hereafter, ‘UE’ may refer to MTC UE, BL (Bandwidth reduced Low complexity)/CE (coverage enhanced) UE, NB-IoT UE, Reduced Capability (RedCap) UE, normal UE and/or IAB-MT (mobile termination).

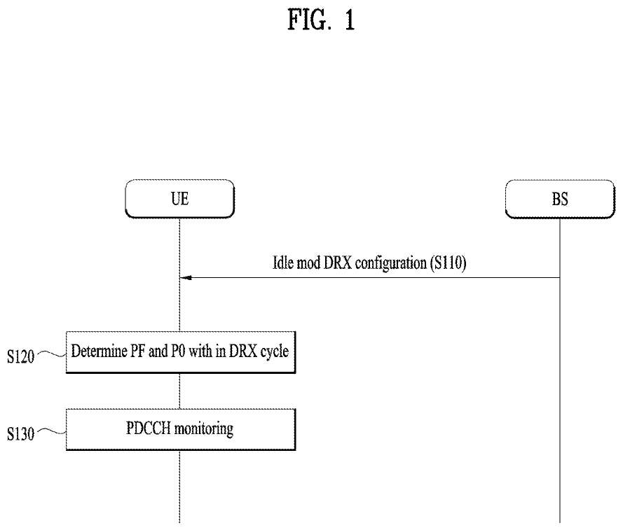

FIG. 1 is a flowchart showing an example of a method of performing an Idle mode DRX operation.

A UE receives, from a base station, Idle mode DRX configuration information through a higher layer signaling (e.g., system information) (S110).

Furthermore, the UE determines a PF (Paging Frame) and a PO (Paging Occasion), for monitoring a physical downlink control channel (e.g., PDCCH) in a paging DRX cycle based on the Idle mode DRX configuration information (S120). In this case, the DRX cycle includes On Duration and sleep duration (or Opportunity for DRX).

Furthermore, the UE monitors a PDCCH in the PO of the determined PF (S130). The UE monitors only one time interval (PO) for each paging DRX cycle. For example, the time interval may be a slot or a subframe.

Additionally, if the UE receives a PDCCH (more exactly, CRC of PDCCH) scrambled by a P-RNTI during On duration (i.e., if paging is detected), the UE may transit to a connected mode and transmit or receive data with the base station.

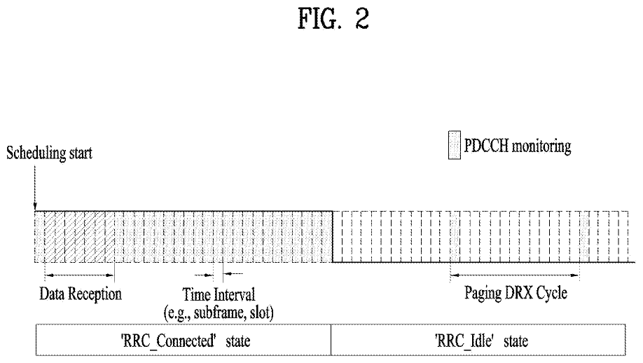

FIG. 2 is a diagram showing an example of an Idle mode DRX operation.

Referring to FIG. 2, if there is a traffic (data) toward a UE in the RRC_Idle state (hereinafter referred to as ‘Idle state’), paging occurs toward the corresponding UE.

Thus, the UE wakes up every (paging) DRX cycle and monitors a PDCCH.

If Paging is present, the UE transits to a Connected state, and receives data. Otherwise, the UE may enter a sleep mode again.

### (2) Connected Mode DRX (C-DRX)

C-DRX is DRX applied in the RRC Connected state. The DRX cycle of C-DRX may be configured with a Short DRX cycle and/or a Long DRX cycle. The Short DRX cycle is Optional.

If C-DRX is configured, a UE performs PDCCH monitoring for On Duration. If there is a PDCCH successfully detected during the PDCCH monitoring, the UE operates (or runs) an inactivity timer and maintains an awake state. In contrast, if there is no PDCCH successfully detected during the PDCCH monitoring, the UE enters to a sleep state after the On Duration is ended.

If C-DRX is configured, a PDCCH reception occasion (e.g., a slot having a PDCCH search space/candidate) may be configured discontiguously based on a C-DRX configuration. In contrast, if C-DRX is not configured, a PDCCH reception occasion (e.g., a slot having a PDCCH search space/candidate) may be configured contiguously in accordance with PDCCH search space configuration. Meanwhile, PDCCH monitoring may be limited in a time interval configured as a measurement gap, regardless of a C-DRX configuration.

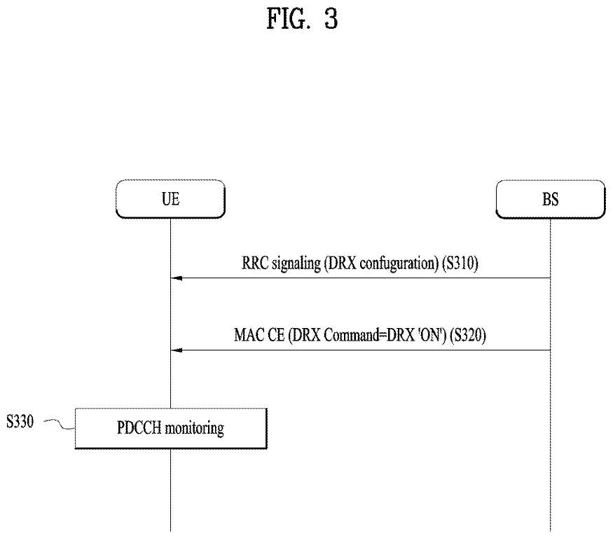

FIG. 3 is a flowchart showing an example of a method of performing a C-DRX operation.

A UE receives, from a base station, RRC signalling (e.g., MAC-MainConfig IE) including DRX configuration information (S310). The DRX configuration information may include the following information.
on-duration: the duration that the UE waits for, after waking up, to receive PDCCHs. If the UE successfully decodes a PDCCH, the UE stays awake and starts the drx-inactivity timer;
onDurationTimer: the duration in which the DRX cycle starts. For example, the duration may refer to a time interval to be continuously monitored at the beginning of a DRX cycle, which may be represented in units of milliseconds (ms).
drx-InactivityTimer: the duration after the PDCCH occasion in which a PDCCH indicates a new UL or DL transmission for the MAC entity. For example, the duration may be a time interval represented in units of ms after the UE decodes the PDCCH including scheduling information. That is, the duration refers to a duration in which the UE waits to successfully decode another PDCCH after decoding the PDCCH. If no other PDCCHs are detected within the corresponding duration, the UE transitions to the sleep mode.

The UE restarts the drx-inactivity timer after successfully decoding a PDCCH for initial transmission only except for a PDCCH for retransmission.
drx-RetransmissionTimer: for DL, the maximum duration until a DL retransmission is received; for UL the maximum duration until a grant for UL retransmission is received. For example, for UL, drx-RetransmissionTimer indicates the number of slots in a bandwidth part (BWP) where a transport block (TB) to be retransmitted is transmitted. For DL, drx-RetransmissionTimer indicates the number of slots in a BWP in which a TB to be retransmitted is received.
longDRX-Cycle: On Duration occurrence period
drxStartOffset: a subframe number in which a DRX cycle is started
drxShortCycleTimer: the duration the UE shall follow the Short DRX cycle;
shortDRX-Cycle: a DRX Cycle operating as much as a drxShortCycleTimer number when Drx-InactivityTimer is terminated
drx-SlotOffset: the delay before drx-onDurationTimer starts. For example, the delay may be expressed in units of ms, and more particularly, in multiples of 1/32 ms.
Active time: total duration that the UE monitors PDCCH, which may include (a) the “on-duration” of the DRX cycle, (b) the time UE is performing continuous reception while the drx-inactivity timer has not expired, and (c) the time when the UE is performing continuous reception while waiting for a retransmission opportunity.

Specifically, when the DRX cycle is configured, an active time for a serving cell of a DRX group includes the following.
(a) drx-onDurationTimer or (b) drx-InactivityTimer configured for the DRX group is running; or
(c) drx-RetransmissionTimerDL or drx-RetransmissionTimerUL is running on any Serving Cell in the DRX group; or
(d) ra-ContentionResolutionTimer or msgB-ResponseWindow is running; or
(e) a Scheduling Request is sent on PUCCH and is pending; or
(f) a PDCCH indicating a new transmission addressed to the C-RNTI of the MAC entity has not been received after successful reception of a Random Access Response for the Random Access Preamble not selected by the MAC entity among the contention-based Random Access Preamble.

Furthermore, if DRX ‘ON’ is configured through the DRX command of a MAC CE (command element) (S320), the UE monitors a PDCCH for the ON duration of a DRX cycle based on the DRX configuration (S330).

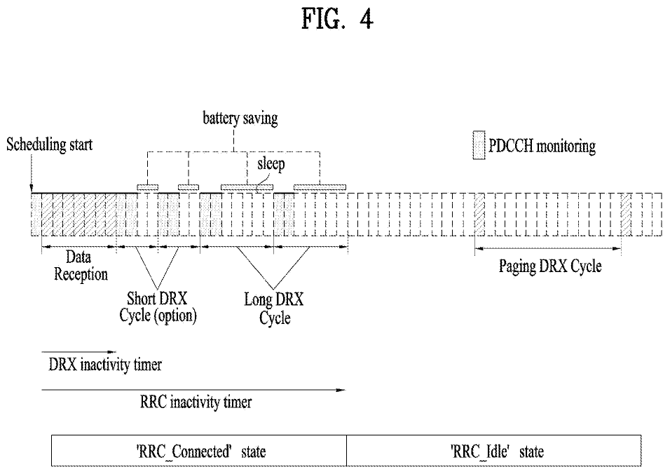

FIG. 4 is a diagram showing an example of a C-DRX operation.

Referring to FIG. 4 when the UE receives scheduling information (e.g., DL assignment or UL grant) in the RRC_Connected state (hereinafter referred to as the connected state), the UE runs a DRX inactivity timer and an RRC inactivity timer.

After the DRX inactivity timer expires, a DRX mode starts. The UE wakes up in a DRX cycle and monitors a PDCCH during a predetermined time (on duration timer).

In this case, if Short DRX is configured, when the UE starts the DRX mode, the UE first starts in a short DRX cycle, and starts to a long DRX cycle after the short DRX cycle is terminated. The Long DRX cycle is a multiple of the short DRX cycle. In the short DRX cycle, the UE wakes up more frequently. After the RRC inactivity timer expires, the UE shifts to an Idle state and performs an Idle mode DRX operation.

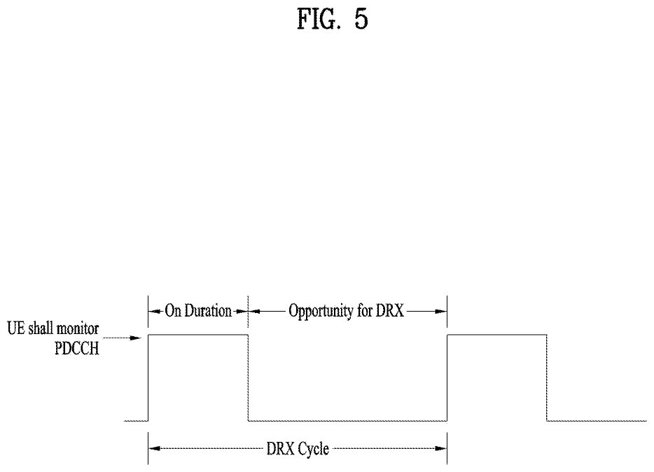

FIG. 5 illustrates a DRX cycle. The C-DRX operation has been introduced for power saving of the UE. If the UE receives no PDCCH within the on-duration defined for each DRX cycle, the UE enters the sleep mode until the next DRX cycle and does not perform transmission/reception.

On the other hand, when the UE receives a PDCCH within the on-duration, the active time may continue (or increase) based on the operations of an inactivity timer, a retransmission timer, etc. If the UE receives no additional data within the active time, the UE may operate in the sleep mode until the next DRX operation.

In NR, a wake-up signal (WUS) has been introduced to obtain additional power saving gain in addition to the existing C-DRX operation. The WUS may be to inform whether the UE needs to perform PDCCH monitoring within the on-duration of each DRX cycle (or a plurality of DRX cycles). If the UE detects no WUS on a specified or indicated WUS occasion, the UE may maintain the sleep mode without performing PDCCH monitoring in one or more DRX cycles associated with the corresponding WUS.

### (3) WUS (DCI Format 2_6)

According to the power saving technology of Rel-16 NR systems, when the DRX operation is performed, it is possible to inform the UE whether the UE needs to wake up for each DRX cycle by DCI format 2_6.

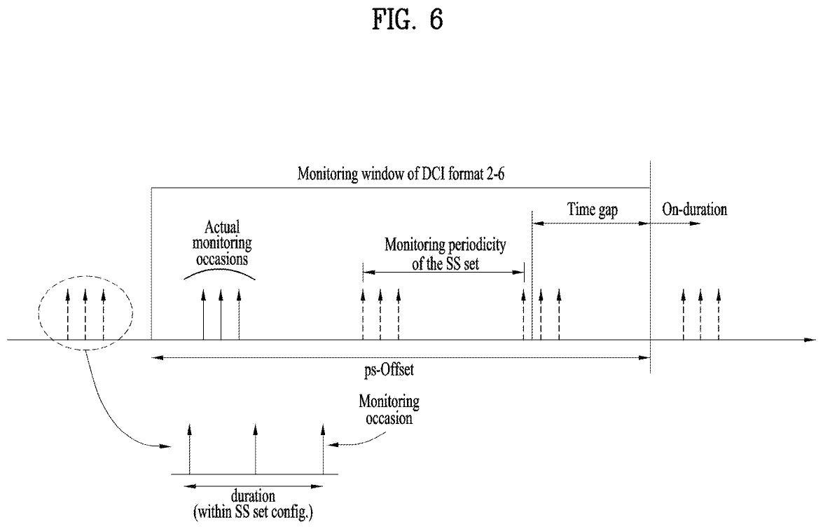

Referring to FIG. 6, a PDCCH monitoring occasion for DCI format 2_6 may be determined by ps-Offset indicated by the network and a time gap reported by the UE. In this case, the time gap reported by the UE may be interpreted as a preparation period necessary for an operation after the UE wakes up.

Referring to FIG. 6, the base station (BS) may provide the UE with a search space (SS) set configuration capable of monitoring DCI format 2_6. According to the corresponding SS set configuration, DCI format 2_6 may be monitored in consecutive slots as long as the duration at the monitoring periodicity interval.

In the DRX configuration, a monitoring window for monitoring DCI format 2_6 may be determined by the start time of the DRX cycle (e.g., a point where the on-duration timer starts) and ps-Offset configured by the BS. In addition, PDCCH monitoring may not be required in the time gap reported by the UE. Consequently, an SS set monitoring occasion on which the UE actually performs monitoring may be determined as a first full duration (i.e., actual monitoring occasions of FIG. 6) within the monitoring window.

If the UE detects DCI format 2_6 in the monitoring window configured based on ps-Offset, the UE may be informed by the BS whether the UE wakes up in the next DRX cycle.

### Search Space Set (SS Set) Group Switching

In the current NR standards, the SS set group switching has been defined to reduce the power consumption of the UE. According to the SS set group switching, the UE may be configured with a plurality of SS set groups, and an SS set group to be monitored by the UE among the plurality of SS set groups may be indicated. In addition, the UE may monitor an SS set included in the corresponding SS set group according to the corresponding indication and skip monitoring of SS sets not included in the corresponding SS set group.

For example, the UE may be provided with a list of SS set groups configured with a Type 3-PDCCH common search space (CSS) set and/or a user-specific search space (USS) set. In addition, if a list of SS set groups is provided, the UE may monitor SS sets corresponding to group index #0.

The UE may perform the SS set group switching operation depending on whether SearchSpaceSwitchTrigger is configured.

If SearchSpaceSwitch Trigger is configured for the UE, the UE may switch the SS set group according to the indication of DCI format 2_0.

For example, if the value of an SS Set Group Switching Flag field in DCI format 2_0 is 0, the UE may start monitoring SS set group #0 after a predetermined time from the time when the UE receives DCI format 2_0 and stop monitoring SS set group #1.

If the value of the SS Set Group Switching Flag field in DCI format 2_0 is 1, the UE may start monitoring SS set group #1 after a predetermined time from the time when the UE receives DCI format 2_0 and stop monitoring SS set group #0. If the UE starts monitoring SS set group #1, the UE may start counting a timer configured by SearchSpaceSwitchTimer. If the timer expires, the UE may start monitoring SS set group #0 after a predetermined time from the time when the timer expires and stop monitoring SS set group #1.

If SearchSpaceSwitch Trigger is not configured for the UE, the UE may change the SS set group based on DCI reception. For example, when the UE receives the DCI while monitoring SS set group #0 (or SS set group #1), the UE may start monitoring SS set group #1 (or SS set group #0) after a predetermined time from the time when the UE receives the DCI and stop monitoring SS set group #0 (or SS set group #1). In this case, the UE may start counting the timer configured by SearchSpaceSwitchTimer. If the timer expires, the UE may start monitoring SS set group #0 (or SS set group #1) after a predetermined time from the time when the timer expires and stop monitoring SS set group #1 (or SS set group #0).

Meanwhile, embodiments to be described later may be applied to, for example, extended reality (XR). XR is a concept that encompasses augmented reality (AR), virtual reality (VR), and mixed reality (MR). XR is characterized in that a timing when traffic is expected to be received is fixed to frames per second (fps) and traffic may be received later or earlier than the expected timing due to the influence of jitter. This jitter of XR traffic is represented as a truncated Gaussian probability distribution. Therefore, a power saving effect may be expected by cyclically configuring DRX according to fps. Even when DRX is not configured, if PDCCH monitoring adaptation is configured, the power saving effect may be expected only by PDCCH monitoring adaptation. It is apparent that the power saving effect may also be expected by configuring both DRX and PDCCH monitoring adaptation.

An expected traffic reception timing and an expected reception timing which is caused by the effect of jitter may be expressed as a probability, and embodiments to be described later may be applied to achieve the power saving effect in an XR environment as described above.

For example, since a jitter probability is low and thus a traffic reception probability is low at a timing which is relatively distant in time from the expected traffic reception timing, the UE may save power by sparsely monitoring a PDCCH. Conversely, since the jitter probability is high and thus the traffic reception probability is high at a timing which is close in time to the expected traffic reception timing, the UE may adjust power consumption according to the reception probability by densely monitoring the PDCCH. For this purpose, SS set group #0 may be configured as an SS set group including an SS set for dense PDCCH monitoring, and SS set group #1 may be configured as an SS set group including an SS set for sparse PDCCH monitoring. In other words, SS set Switching operation may be configured considering jitter in XR. In other words, an SS set switching operation may be configured considering jitter in XR.

As another example, the UE may repeat an operation of performing PDCCH monitoring during a short duration in which the traffic reception probability is high due to a high jitter probability and then entering micro-sleep. Therethrough, when traffic is not normally received, the UE may quickly enter micro-sleep to achieve power saving and then perform PDCCH monitoring to receive retransmitted traffic, thereby increasing the efficiency of PDCCH monitoring. In other words, a PDCCH monitoring skipping operation may be configured considering jitter in XR.

While the present disclosure proposes an operation through DCI reception within a DRX active time as an example, an operation of the same scheme may be applied to a UE for which DRX is not configured.

The present disclosure proposes methods of performing monitoring for a Type0/0A/1/2-PDCCH CSS set for power saving gain.

The UE may be configured with a maximum of 10 SS sets per BWP. The UE may monitor PDCCH candidates included in SS sets (hereinafter, monitoring of SS sets).

Since the UE needs to perform blind decoding (BD), a reception timing and a received DCI format of which are not known by the UE, PDCCH monitoring among DRX operations occupies a large portion of power consumption.

As technology for power saving in a wireless communication system (e.g., Rel-17 NR system), PDCCH monitoring adaptation through which the UE adjusts the number of times of PDCCH monitoring in order to reduce power consumption within a DRX active time is under discussion. In general, PDCCH monitoring adaptation may mean an operation for reducing the number of times of PDCCH monitoring.

Examples of PDCCH monitoring adaptation include PDCCH monitoring skipping (hereinafter, skipping) and SS set group switching (hereinafter, switching).

For PDCCH monitoring adaptation, a BS may indicate, to the UE, information related to PDCCH monitoring adaptation using various DCI formats. The UE may monitor a PDCCH according to a PDCCH monitoring adaptation operation based on the corresponding indication.

An embodiment of the present disclosure proposes operation methods of the UE in which the UE adjusts the number of times of monitoring for Type0/0A/1/2-PDCCH CSS sets. Table 3 is an excerpt from 3GPP TS 38.213 defining the Type0/0A/1/2-PDCCH CSS sets.

TABLE 3
A set of PDCCH candidates for a UE to monitor is defined in terms of PDCCH search
space sets. A search space set can be a CSS set or a USS set. A UE monitors PDCCH
candidates in one or more of the following search spaces sets
- a Type0-PDCCH CSS set configured by pdcch-ConfigSIB1 in MIB or by
searchSpaceSIB1 in PDCCH-ConfigCommon or by searchSpaceZero in PDCCH-
ConfigCommon for a DCI format with CRC scrambled by a SI-RNTI on the primary cell of
the MCG
- a Type0A-PDCCH CSS set configured by searchSpaceOtherSystemInformation in
PDCCH-ConfigCommon for a DCI format with CRC scrambled by a SI-RNTI on the
primary cell of the MCG
- a Type1-PDCCH CSS set configured by ra-SearchSpace in PDCCH-
ConfigCommon for a DCI format with CRC scrambled by a RA-RNTI, a MsgB-RNTI, or a
TC-RNTI on the primary cell
- a Type2-PDCCH CSS set configured by pagingSearchSpace in PDCCH-
ConfigCommon for a DCI format with CRC scrambled by a P-RNTI on the primary cell of
the MCG
- a Type3-PDCCH CSS set configured by SearchSpace in PDCCH-Config with
searchSpaceType = common for DCI formats with CRC scrambled by INT-RNTI, SFI-
RNTI, TPC-PUSCH-RNTI, TPC-PUCCH-RNTI, TPC-SRS-RNTI, CI-RNTI, or PS-RNTI
and, only for the primary cell, C-RNTI, MCS-C-RNTI, or CS-RNTI(s), and
- a USS set configured by SearchSpace in PDCCH-Config with searchSpaceType =
ue-Specific for DCI formats with CRC scrambled by C-RNTI, MCS-C-RNTI, SP-CSI-
RNTI, CS-RNTI(s), SL-RNTI, SL-CS-RNTI, or SL-L-CS-RNTI.

In Table 3, the usage of each CSS may be classified as follows.
Type0-PDCCH CSS set: Initial access
Type0A-PDCCH CSS set: Reception of additional system information (on-demand system information (OSI)) at the request of the UE
Type1-PDCCH CSS set: Reception of a response of a network at the request of the UE in a random access procedure
Type2-PDCCH CSS set: Change of system information and indication (or paging) of a public warning system (PWS)
Type3-PDCCH CSS set: Other CSSs

As may be appreciated in Table 3, Type0/0A/1/2-PDCCH CSS sets (hereinafter referred to as Type0/0A/1/2-CSSs) identify RNTIs that CRC-scramble downlink control information (DCI). For example, DCI transmitted through a Type0/0A-CSS is scrambled based on an SI-RNTI. DCI transmitted through a Type1-CSS is scrambled based on an RA-RNTI, an MsgB-RNTI, and a TC-RNTI. Additionally, DCI transmitted through a Type2-CSS is scrambled based on a P-RNTI.

The TC-RNTI of the Type1-CSS is an RNTI related to Msg3 and Msg4 according to a random access procedure of the UE and is not considered as a target to which PDCCH monitoring adaptation in the present disclosure is applied. When a corresponding RNTI is described in the present disclosure, the RNTI refers to a separate RNTI that CRC-scrambles the DCI in a CSS of each type.

For example, an RNTI corresponding to the Type0/0A-CSS is the SI-RNTI, an RNTI corresponding to the Type1-CSS is the RA-RNTI and the MsgB-RNTI, and an RNTI corresponding to the Type2-CSS is the P-RNTI.

Referring to Table 4 extracted from 3GPP TS38.213, for the Type0/0A/1/2-CSS, the UE may perform monitoring with a C-RNTI in addition to a corresponding RNTI.

TABLE 4

| | |
|---|---|
| If a UE is provided | |
| - | one or more search space sets by corresponding one or more of searchSpaceZero, |
| | searchSpaceSIB1, searchSpaceOtherSystemInformation, pagingSearchSpace, ra- |
| | SearchSpace, and |
| - | a C-RNTI, an MCS-C-RNTI, a CS-RNTI, a SL-RNTI, a SL-CS-RNTI, or a SL Semi- |
| | Persistent Scheduling V-RNTI |

the UE monitors PDCCH candidates for DCI format 0_0 and DCI format 1_0 with CRC
scrambled by the C-RNTI, the MCS-C-RNTI, or the CS-RNTI in the one or more search
space sets in a slot where the UE monitors PDCCH candidates for at least a DCI format
0_0 or a DCI format 1_0 with CRC scrambled by SI-RNTI, RA-RNTI, MsgB-RNTI, or P-
RNTI.

The present disclosure proposes a method of performing PDCCH monitoring differently for each RNTI. An operation in which the UE receives and decodes DCI and an operation in which the UE descrambles a CRC of the DCI based on a specific RNTI, which are operations of the UE in the NR standard, are referred to as specific RNTI monitoring. For example, an operation in which the UE receives DCI 0_0 or DCI 1_0 in a Type2-CSS and then CRC-descrambles DCI 0_0 or DCI 1_0 based on a P-RNTI may be referred to as P-RNTI monitoring. Additionally, monitoring adaptation that adjusts the number of P-RNTI monitoring operations of the UE (e.g., reducing or eliminating the number of P-RNTI monitoring operations) may simply be referred to as P-RNTI monitoring adaptation.

In this disclosure, for convenience of explanation, an operation in which the UE monitors a PDCCH based on the SI-RNTI, the RA-RNTI, the MsgB-RNTI, or the P-RNTI for the Type0/0A/1/2-PDCCH CSS set, which is the operation of the UE in the current NR standard, is referred to as first PDCCH monitoring. That is, an operation in which the PDCCH is monitored based on an RNTI rather than a C-RNTI is referred to as first PDCCH monitoring. For example, first PDCCH monitoring means monitoring the PDCCH based on the SI-RNTI for the Type0/0A-CSS, monitoring the PDCCH based on the RA-RNTI or the MsgB-RNTI for the Type1-CSS, and monitoring the PDCCH based on the P-RNTI for the Type2-CSS.

Meanwhile, monitoring the PDCCH by the UE based on the C-RNTI for the Type0/0A/1/2-PDCCH CSS set is referred to as second PDCCH monitoring.

In the present disclosure, expressions such as “first” and “second” may be omitted if a person skilled in the art may clearly understand the meaning without confusion. For example, PDCCH monitoring may mean either a first PDCCH monitoring method or a second PDCCH monitoring method, or both first PDCCH monitoring and second PDCCH monitoring, depending on a flow of explanation.

Search space set group (SSSG) switching, introduced for power saving in NR Rel-17, is based on technology introduced in the NR Rel-16 standard. In Rel-16 based SSSG switching, the Type0/0A/1/2-CSS may not be included in any SSSG. In other words, the UE should always monitor the Type0/0A/1/2-CSS regardless of an SSSG that the UE is currently monitoring.

However, in order to save power in Rel-17, PDCCH monitoring skipping through which the UE does not monitor all PDCCHs is also considered. Even when PDCCH monitoring skipping is indicated to the UE, if the Type0/0A/1/2-CSS should always be monitored, a problem may arise in terms of power saving efficiency, which is an effect desired by the PDCCH monitoring skipping operation.

In order to solve this problem, the present disclosure proposes methods in which the UE may or may not perform a monitoring operation of the Type0/0A/1/2-CSS. Therefore, by the methods proposed in the present disclosure, the UE that monitors a PDCCH using an existing (Rel-15/16/17 NR) DRX cycle may obtain an advantageous effect in improving power consumption efficiency by adjusting the number of times of PDCCH monitoring.

Hereinafter, while the present disclosure will describe a proposed method based on C-DRX applied to a UE in an RRC_CONNECTED state, the present disclosure is not limited thereto. For example, those skilled in the art may easily infer that the proposed method may extensively be applied to other methods (e.g., DRX applied to a UE in an RRC_IDLE state) in which a certain duration in which the UE does not need to expect reception of DL signals may be defined with periodicity.

Therefore, it is obvious that methods proposed in the present disclosure may be applied to all types of transmission and reception methods expected by the BS and the UE, even if there is no separate explanation, as long as the principle of the present disclosure is not violated. Hereinafter, in the present disclosure, for convenience of explanation, the term DRX is used as a general concept including the term C-DRX.

While the present disclosure describes an example based on an NR system in order to explain the principle of the present disclosure, the proposed methods are not limited to a specific transmission and reception form of NR unless otherwise stated. In addition, while the present disclosure describes an example based on the characteristics and structures of a UE supporting C-DRX in order to explain the principle of the present disclosure, the proposed methods are not limited to a specific UE supporting C-DRX unless otherwise stated. Therefore, it is obvious that the methods proposed in the present disclosure may be applied to all structures and services of wireless communication transmission and reception even if there is no separate explanation, as long as the principle of the present disclosure is not violated.

In the following description, separation between methods or between options is intended to clarify explanation and is not limited to the meaning that each method and option should necessarily be implemented in an independent manner. For example, while the methods/options described below may be implemented individually, at least some thereof may be implemented in combination within the extent that they do not conflict with each other.

Now, operation processes of the UE and the BS according to an embodiment of the present disclosure will be described.

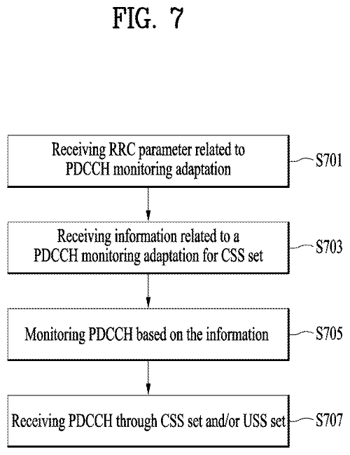

For example, when a UE in an RRC_CONNECTED mode in communication systems such as LTE and NR systems is configured with a DRX operation and an operation according to embodiments proposed in the present disclosure, the UE may operate as illustrated in FIGS. 7 to 9 upon receiving DCI format x_1 and/or DCI format x_2. In this case, x is an arbitrary integer and may mean various DCI formats.

FIG. 7 illustrates an overall operation process of a UE according to an embodiment of the present disclosure.

Referring to FIG. 7, the UE may receive an RRC parameter related to PDCCH monitoring adaptation (S701). Information included in the RRC parameter may be based on, for example, at least one of [Method 1] to [Method 3] described later.

The UE may receive information related to PDCCH monitoring adaptation for a CSS set (S703). For example, the UE may receive the information through a MAC-control element (CE) or DCI.

The UE may monitor and receive a PDCCH through the CSS set and/or a USS set based on the received information (S705 and S707). For example, the UE may receive the corresponding information and perform monitoring and reception of the PDCCH, based on at least one of [Method 1] to [Method 3] described later.

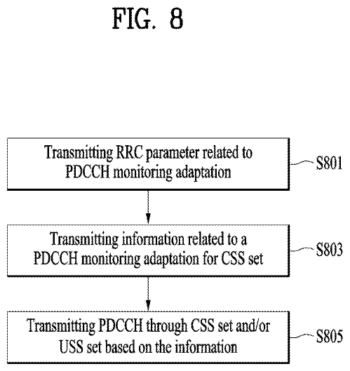

FIG. 8 illustrates an overall operation process of a BS according to an embodiment of the present disclosure.

Referring to FIG. 8, the BS may transmit an RRC parameter related to PDCCH monitoring adaptation (S801). Information included in the RRC parameter may be based on, for example, at least one of [Method 1] to [Method 3] described later.

The BS may transmit information related to PDCCH monitoring adaptation for a CSS set (S803). For example, the BS may transmit the information through a MAC-CE or DCI.

The BS may transmit a PDCCH through the CSS set and/or a USS set based on the transmitted information (S805). For example, the BS may transmit the corresponding information and the PDCCH based on at least one of [Method 1] to [Method 3] described later.

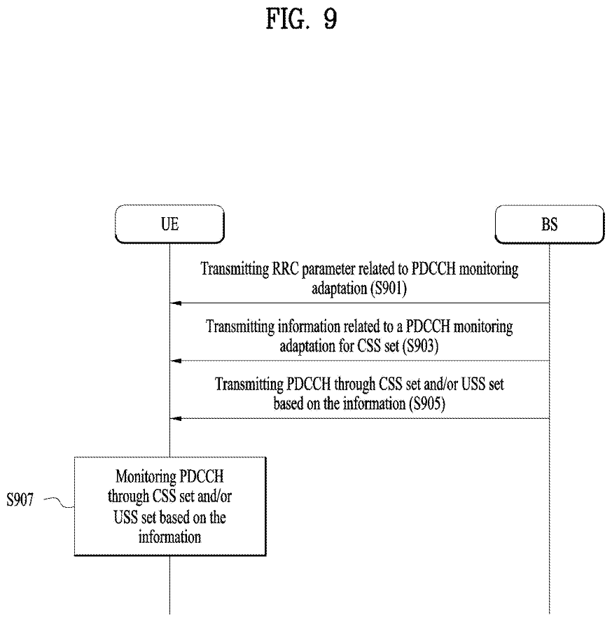

FIG. 9 illustrates an overall operation process of a network according to an embodiment of the present disclosure.

Referring to FIG. 9, the BS may transmit an RRC parameter related to PDCCH monitoring adaptation to the UE (S901). Information included in the RRC parameter may be based on, for example, at least one of [Method 1] to [Method 3] described later.

The BS may transmit information related to PDCCH monitoring adaptation for a CSS set to the UE (S903). For example, the BS may transmit the information to the UE through a MAC-CE or DCI.

The BS may transmit a PDCCH to the UE through the CSS set and/or a USS set based on the transmitted information (S805). For example, the BS may transmit the corresponding information and the PDCCH to the UE based on at least one of [Method 1] to [Method 3] described later.

The UE may monitor and receive the PDCCH through the CSS set and/or the USS set based on the information transmitted by the BS (S907). For example, the UE may receive the corresponding information from the BS and perform monitoring and reception of the PDCCH, based on at least one of [Method 1] to [Method 3] described later.

In other words, at least one of embodiments described later may be applied to the operation of the UE based on PDCCH monitoring adaptation (e.g., a changed PDCCH monitoring method). In FIGS. 7 to 9, while it is assumed that the network explicitly or implicitly indicates the operation of the UE based on PDCCH monitoring adaptation through the DCI, the present disclosure is not limited thereto. For example, PDCCH monitoring adaptation may also be indicated through the MAC-CE.

Meanwhile, PDCCH monitoring adaptation may be initiated after a certain time from reception or termination of reception of DCI format x_1 and/or DCI format x_2. For example, the certain time may be predefined, signaled through RRC, or determined through DCI format x_1 and/or DCI format x_2.

To indicate release/termination of the operation of the UE based on PDCCH monitoring adaptation, the same method as that used in initiation of the operation of the UE based on PDCCH monitoring adaptation may be used. For example, if initiation of PDCCH monitoring adaptation is indicated through the DCI, release/termination of PDCCH monitoring adaptation may also be indicated through the DCI. As another example, if initiation of PDCCH monitoring adaptation is indicated through the MAC-CE, release/termination of PDCCH monitoring adaptation may also be indicated through the MAC-CE.

As PDCCH monitoring adaptation is initiated, the UE may continuously perform an operation according to PDCCH monitoring adaptation, which will be described later, until a termination indication timing of the operation, periodically perform the operation, perform the operation only during a certain time (e.g., based on a timer), or terminate the operation as event conditions for terminating the operation are satisfied.

Meanwhile, PDCCH monitoring adaptation, which will be described later, may be configured for each aggregation level (AL)/SS set/DCI format to be monitored. PDCCH monitoring adaptation may not be applied to a specific AL/specific SS set/specific DCI format as an exceptional case. A fallback operation of the UE/BS may be defined in relation to PDCCH monitoring adaptation. For example, an operation for handling an error case such as misalignment of PDCCH monitoring adaptation between the BS and the UE due to the UE failing to detect DCI indicating PDCCH monitoring adaptation may be defined.

In relation to all of the operations described with reference to FIGS. 7 to 9, the BS (or gNB) may configure related RRC parameters for the UE. The RRC parameters may include configurations related to PDCCH monitoring adaptation (e.g., a configuration of an SSSG and a duration of PDCCH monitoring adaptation) described in the present disclosure.

In the embodiments proposed in the present disclosure, some of proposed methods may be selectively applied. The methods may be performed independently without combination with other methods, or one or more methods may be combined and performed in an associated form. Some terms, symbols, sequences, etc. used to describe the present disclosure may be replaced with other terms, symbols, sequences, etc. as long as the principle of the present disclosure is maintained.

Hereinafter, while the present disclosure exemplarily describes an arbitrary structure for PDCCH monitoring adaptation and transmission and reception of DCI format x_1 and/or DCI format x_2 in order to explain the principle of the present disclosure, the proposed methods are not limited to specific DRX or a specific transmission and reception form of DCI. Therefore, it is obvious that the embodiments proposed in the present disclosure may be applied to a PDCCH monitoring operation of a Type0/0A/1/2-PDCCH CSS set even if there is no separate explanation, as long as the corresponding principle is not violated.

In the present disclosure, it is assumed that, while the UE is performing a DRX operation, PDCCH monitoring adaptation (e.g., SSSG switching and/or PDCCH monitoring skipping) is indicated by the BS, and the UE performs corresponding PDCCH monitoring adaptation. Here, SSSG switching refers to reducing the number of monitored SS sets to some, but not all, and PDCCH monitoring skipping refers to stopping PDCCH monitoring for a certain time.

For example, SSSG switching may define two SSSGs containing SS sets. In this case, each SSSG may generally include fewer SS sets than the number of SS sets that may be configured in one BWP of the UE. The UE is indicated to monitor only one SSSG among the two SSSGs. Compared to monitoring all SS sets that may be configured in one BWP of an NR UE, since fewer SS sets are monitored, a power saving effect may be achieved. However, there are not necessarily two SSSGs configured for the UE, and three or more SSSGs may be configured depending on configuration.

PDCCH monitoring skipping means, for example, stopping PDCCH monitoring during a specific duration indicated to the UE. A PDCCH monitoring skipping duration of the UE may be set to one or more symbols or one or more slots or may be set up to the next DRX cycle. Through the PDCCH monitoring skipping operation, the UE stops PDCCH monitoring for a short time, allowing the UE to achieve a micro-sleep effect and achieve a power saving effect.

The present disclosure proposes methods for the UE to adjust monitoring for Type0/0A/1/2-CSSs. By proposing an operation for each RNTI of the UE for corresponding CSSs, the UE may achieve an advantageous effect in adjusting the number of times of PDCCH monitoring while improving power consumption efficiency. In addition, the present disclosure proposes a C-RNTI monitoring method of the UE and additionally proposes P-RNTI monitoring adaptation for a Type2-CSS. In addition to the corresponding monitoring methods, the present disclosure proposes a method in which the UE may temporarily prioritize a USS over a CSS to monitor PDCCH candidates and non-overlapped CCEs.

[Method 1] The number of times of C-RNTI monitoring of the UE for Type0/0A/1/2-PDCCH CSS set(s) may be adjusted.

As described above, according to SSSG switching introduced in the Rel-16 NR standard, the Type0/0A/1/2-CSS is not affected by the SSSG switching operation. In other words, the Type0/0A/1/2-CSS is always monitored regardless of an SSSG that the UE is currently monitoring.

However, in Rel-17 power saving, it was agreed that SSSG switching and PDCCH monitoring skipping would be designed in common. Therefore, it may not be appropriate for a UE for which a PDCCH monitoring adaptation operation for Rel-17 power saving may be configured to always continue monitoring for the Type0/0A/1/2-CSS.

Therefore, in order to solve the above-mentioned problem and increase a power saving effect, a PDCCH monitoring adaptation operation for the Type0/0A/1/2-CSS may be considered, unlike a Rel-16 SSSG switching operation.

First PDCCH monitoring of the UE for the Type0/0A/1/2-CSS (e.g., PDCCH monitoring based on an SI-RNTI, an RA-RNTI, an MsgB-RNTI, and/or a P-RNTI) is performed by the UE in a certain situation as necessary. That is, in a situation in which first PDCCH monitoring is not required, the UE does not perform PDCCH monitoring operations based on the SI-RNTI, the RA-RNTI, the MsgB-RNTI, and/or the P-RNTI for the Type0/0A/1/2-CSS. In other words, the UE operating general C-DRX, not in a specific situation, may not need PDCCH monitoring adaptation for first PDCCH monitoring.

The UE may perform second PDCCH monitoring (e.g., C-RNTI based PDCCH monitoring) for the Type0/0A/1/2-CSS, and a PDSCH may be scheduled from the BS through second PDCCH monitoring. In general, considering that a C-RNTI based PDSCH may be scheduled even through a Type3-CSS and a USS, a C-RNTI monitoring operation for the Type0/0A/1/2-CSS needs to be adjusted through PDCCH monitoring adaptation.

[Method 1] in the present disclosure proposes a method in which the UE performs C-RNTI monitoring adaptation for the Type0/0A/1/2-CSS.

For the above-described C-RNTI monitoring operation of the UE, the BS may indicate/configure a second PDCCH monitoring operation proposed in [Method 1-1] to [Method 1-3] to/for the UE. For example, the BS may configure the monitoring operation through a higher layer parameter (e.g., RRC parameter) so that the UE may operate according to at least one of [Method 1-1] to [Method 1-3] or may not operate according to any method of [Method 1-1] to [Method 1-3]. If the BS configures the monitoring operation such that the UE does not operate according to any method, the UE may perform PDCCH monitoring based on the C-RNTI, the SI-RNTI, the RA-RNTI, the MsgB-RNTI, and/or the P-RNTI for the Type0/0A/1/2-PDCCH CSS set(s), in the same manner as an existing method.

Alternatively, the BS may configure the monitoring operation through the higher layer parameter to enable the UE to use a plurality of methods among [Method 1-1] to [Method 1-3] and then the BS may indicate one method among the plurality of methods through DCI and/or a MAC CE.

[Method 1-1] The UE performs first PDCCH monitoring for the Type0/0A/1/2-PDCCH CSS set(s) as needed and does not perform second PDCCH monitoring.

As described above, the UE performs C-RNTI monitoring for the Type0/0A/1/2-CSS. This means that the BS may schedule a PDSCH for the UE using fallback DCI through the Type0/0A/1/2-CSS.

However, the BS will instruct the UE to perform PDCCH monitoring adaptation in a situation in which there is little or no expected data transmission, and in general, the UE reduces the number of times of PDCCH monitoring performed thereby through an SSSG switching or PDCCH monitoring skipping operation in this situation, resulting in a power saving effect.

Therefore, in this situation, it may be unlikely that the BS will schedule the PDSCH for the UE using fallback DCI through the Type0/0A/1/2-CSS. If the UE is monitoring SSSG #1, the BS may schedule the PDSCH through scheduling DCI rather than the fallback DCI and at the same time indicate switching to SSSG #0. Alternatively, the BS may indicate switching first to SSSG #0 through another DCI format (e.g., DCI format 2_6) and then cause the UE to expect PDSCH scheduling. Here, SSSG #1 is an SSSG in which the number of SS sets included in an SSSG is relatively small or the number of times of monitoring is small, and SSSG #1 monitoring may be indicated for power saving purposes. Alternatively, SSSG #0 may be an SSSG in which the number of SS sets included in the SSSG is relatively large or the number of times of monitoring is large, and SSSG #0 monitoring may be indicated for effective data transmission when there is a lot of data traffic or when data traffic needs to be transmitted during a relatively long duration.

As in the above example, if the BS indicates switching to SSSG #0 through the scheduling DCI or another DCI format (e.g., DCI format 2_6) and/or schedules the PDSCH, the UE may not perform second PDCCH monitoring for the Type0/0A/1/2-CSS. In this case, the UE may achieve a power saving effect by adjusting the number of times of second PDCCH monitoring for the Type0/0A/1/2-CSS. Therefore, in addition to the PDCCH monitoring adaptation operation currently being discussed, second PDCCH monitoring for the Type0/0A/1/2-CSS may additionally be configured for the UE.

That is, [Method 1-1] proposes that the UE should perform first PDCCH monitoring for the Type0/0A/1/2-CSS in the same manner as the existing method and should not perform second PDCCH monitoring for the Type0/0A/1/2-CSS.

In which situation the UE will perform the operation of [Method 1-1] may be configured in various ways.

For example, the UE may be configured to perform the operation of [Method 1-1] for all PDCCHs of the UE or only for the case in which PDCCH monitoring adaptation is indicated by the BS. The UE may perform PDCCH monitoring adaptation according to [Method 1-1] during an indicated PDCCH monitoring adaptation duration. For example, the PDCCH monitoring adaptation duration for performing [Method 1-1] may be (i) a specific duration configured by the BS, (ii) a predetermined duration, (iii) a duration before a DRX active time ends from a time at which DCI indication is received, or (iv) N slots (where N is a natural number) from the start of the DRX active time.

For example, the UE may perform first PDCCH monitoring for the Type0/0A/1/2-CSS in the same manner as the existing method and may not perform second PDCCH monitoring for the Type0/0A/1/2-CSS. Since first PDCCH monitoring is performed only in a situation in which the corresponding operation is necessary, such as in beam failure recovery, a normal C-DRX UE may be expected to perform the first PDCCH monitoring operation with a low probability. Therefore, if the UE does not perform second PDCCH monitoring for the Type0/0A/1/2-CSS through [Method 1-1], significant power saving gain may be achieved.

For example, upon receiving SSSG switching to SSSG #1 that includes only the Type1-CSS and does not include the Type0/0A/2-CSS, the UE may perform first PDCCH monitoring for the Type0/0A/1/2-CSS during a predetermined specific duration in the same manner as the existing method, perform second PDCCH monitoring only for the Type-1-CSS, and not perform second PDCCH monitoring for the Type0/0A/1/2-CSS. Here, the specific duration may be, for example, a time for continuing monitoring of a corresponding SSSG when switching to a specific SSSG is indicated and may be determined through a higher layer parameter (e.g., RRC) or may be a fixed value.

Unlike Rel-16 SSSG switching, the Type0/0A/1/2-CSS may also be configured to be included in a specific SSSG. An SSSG in which the Type0/0A/1/2-CSS is included may be configured independently. Each CSS may be included in all SSSGs or may not be included in any SSSG. If the Type0/0A/1/2-CSS is not included in a specific SSSG, it may be necessary to explicitly indicate that the UE operates not to perform only C-RNTI monitoring for the CSS. For example, if a specific CSS is not included in a specific SSSG, when monitoring for the specific SSSG is indicated, explicit indication that C-RNTI monitoring is not performed in the specific CSS but SI-RNTI, RA-RNTI, MsgB-RNTI, and/or P-RNTI monitoring is performed may be given to the UE.

[Method 1-2] The UE performs second PDCCH monitoring only for an SS set for which first PDCCH monitoring for the Type0/0A/1/2-PDCCH CSS set(s) has actually been performed.

[Method 1-2] proposes an operation in which the UE performs first PDCCH monitoring for the Type0/0A/1/2-CSS in the same manner as the existing method and performs second PDCCH monitoring only for an SS set for which first PDCCH monitoring has actually been performed with respect to the Type0/0A/1/2-CSS. In which situation the UE will perform the operation of [Method 1-2] may be configured in various ways.

For example, the UE may be configured to perform the operation of [Method 1-2] for all PDCCHs of the UE or only for the case in which PDCCH monitoring adaptation is indicated by the BS. The UE may perform PDCCH monitoring adaptation according to [Method 1-2] during an indicated PDCCH monitoring adaptation duration.

For example, the PDCCH monitoring adaptation duration for performing [Method 1-2] may be (i) a specific duration configured by the BS, (ii) a predetermined duration, (iii) a duration before a DRX active time ends from a time at which DCI indication is received, or (iv) N slots (where N is a natural number) from the start of the DRX active time.

In [Method 1-2], whether to perform second PDCCH monitoring is determined depending on whether the UE has actually performed first PDCCH monitoring. Whether to perform second PDCCH monitoring in the Type0/0A-CSS may be determined depending on whether the UE has performed SI-RNTI monitoring for the Type0/0A-CSS. Additionally, whether to perform second PDCCH monitoring in the Typel-CSS may be determined depending on whether the UE has performed RA-RNTI or MsgB-RNTI monitoring for the Type1-CSS. Additionally, whether to perform second PDCCH monitoring in the Type2-CSS may be determined depending on whether the UE has performed P-RNTI monitoring for the Type2-CSS.

For example, the UE may perform first PDCCH monitoring for the Type0/0A/1/2-CSS in the same manner as the existing method and determine whether to perform second PDCCH monitoring for the Type0/0A/1/2-CSS depending on whether first PDCCH monitoring has been performed. Since first PDCCH monitoring is performed only in a situation in which a corresponding operation is necessary (e.g., beam failure recovery), the normal C-DRX UE may be expected to perform the first PDCCH monitoring operation with a low probability. Accordingly, the operation of [Method 1-2] for the UE indicated to perform PDCCH monitoring skipping may be the same as the operation of [Method 1-1]. For example, since the first PDCCH monitoring operation itself will be performed by the UE with a low probability, the same effect as the case in which the UE does not monitor the PDCCH at all for a certain duration may occur. As another example, if the PDCCH monitoring skipping operation of first PDCCH monitoring is configured for the UE, second PDCCH monitoring may be automatically skipped during a PDCCH monitoring skipping duration by [Method 1-2].

Therefore, the UE may achieve power saving gain by not performing second PDCCH monitoring for the Type0/0A/1/2-CSS through [Method 1-2]. In other words, the UE may achieve significant power saving by performing second PDCCH monitoring for the Type0/0A/1/2-CSS with a very small number of times through [Method 1-2].

In addition, second PDCCH monitoring is performed only for the CSS on which first PDCCH monitoring has been performed through [Method 1-2], so that scheduling data associated with first PDCCH monitoring or data that should be scheduled at a timing at which the CSS on which first PDCCH monitoring has been performed is configured may be efficiently scheduled.

For example, upon receiving an indication indicating SSSG switching to SSSG #1 that includes only the Typel-CSS and does not include the Type0/0A/2-CSS, the UE may perform first PDCCH monitoring for the Type0/0A/1/2-CSS during a specific duration in the same manner as the existing method and perform second PDCCH monitoring only when first PDCCH monitoring for the Type1-CSS has been performed. Additionally, second PDCCH monitoring for the Type0/0A/2/-CSS may not be performed. Here, the specific duration may be, for example, a time for continuing monitoring for a corresponding SSSG when switching to a specific SSSG is indicated and may be determined through a higher layer parameter (e.g., RRC) or may be a fixed value.

Unlike Rel-16 SSSG switching, the Type0/0A/1/2-CSS may also be configured to be included in a specific SSSG. An SSSG in which the Type0/0A/1/2-CSS is included may be configured independently. Each CSS may be included in all SSSGs or may not be included in any SSSG. If the Type0/0A/1/2-CSS is not included in a specific SSSG, it may be necessary to explicitly indicate that the UE operates to perform C-RNTI monitoring for the CSS only when the UE has performed first PDCCH monitoring. For example, if a specific CSS is not included in a specific SSSG, when monitoring for the specific SSSG is indicated, explicit indication that C-RNTI monitoring for the CSS may be performed only when SI-RNTI, RA-RNTI, MsgB-RNTI, and/or P-RNTI monitoring is performed may be given.

Meanwhile, if the PDCCH monitoring adaptation operation is indicated to the UE, the UE may be automatically configured to perform the second PDCCH monitoring operation for the Type0/0A/1/2-CSS without separate indication and/or configuration by the BS based on [Method 1-1] or [Method 1-2].

[Method 1-3] The timing/period of second PDCCH monitoring for Type0/0A/1/2-PDCCH CSS set(s) may be configured for the UE by the BS as needed.

[Method 1-3] proposes an operation in which the UE performs first PDCCH monitoring for the Type0/0A/1/2-CSS in the same manner as the existing method, and the BS configures the timing and period of second PDCCH monitoring for the Type0/0A/1/2-CSS. For example, the UE performing [Method 1-3] performs second PDCCH monitoring for the Type0/0A/1/2-PDCCH CSS set(s) only at a timing and/or during a period configured by the BS, and does not perform second PDCCH monitoring in other PDCCH monitoring occasions (MOs). According to [Method 1-3], the number of times of PDCCH monitoring is reduced by performing second PDCCH monitoring only in some of PDCCH MOs configured for the Type0/0A/1/2-PDCCH CSS set(s) and thus power saving gain may be achieved.

Among configured PDCCH MOs, the timing and/or period for performing second PDCCH monitoring for the Type0/0A/1/2-PDCCH CSS set(s) may be variously configured, for example, as (i) odd or even PDCCH MOs, (ii) a PDCCH MO corresponding to a multiple of n (where n is a natural number), (iii) the first and last PDCCH MOs within a DRX active time, or (iv) m (where m is a natural number) PDCCH MOs after indicated PDCCH monitoring adaptation (e.g., SSSG switching or PDCCH monitoring skipping) is terminated.

According to [Method 1-3], the UE may perform second PDCCH monitoring based on the timing and/or period indicated/configured by the BS. For example, SI-RNTI monitoring for the Type0/0A-CSS, RA-RNTI or MsgB-RNTI monitoring for the Type1-CSS, and P-RNTI monitoring for the Type2-CSS may be performed as needed regardless of indicated PDCCH monitoring adaptation, and C-RNTI monitoring for the Type0/0A/1/2-CSS may be performed only at a configured timing and/or during a configured period.

For example, the UE may perform first PDCCH monitoring for the Type0/0A/1/2-CSS in the same manner as the existing method and perform second PDCCH monitoring for the Type0/0A/1/2-CSS at a specific timing or during a specific period.

Since first PDCCH monitoring is performed only in a situation in which the corresponding operation is necessary (e.g., beam failure recovery), the normal C-DRX UE may be expected to perform the first PDCCH monitoring operation with a low probability. Unlike [Method 1-1] and [Method 1-2], [Method 1-3] configures a timing when second PDCCH monitoring for the Type0/0A/1/2-PDCCH CSS set(s) should necessarily be performed, so that the case in which monitoring is not performed at all may not occur.

Therefore, if the Type0/0A/1/2-PDCCH CSS set is located at a timing when the BS desires to schedule the PDSCH, since the BS may schedule the PDSCH through a CSS configured at that timing through [Method 1-3], flexibility in scheduling may also be expected.

Additionally, the UE may expect power saving gain by reducing the number of times of second PDCCH monitoring for the Type0/0A/1/2-CSS through [Method 1-3].

The BS may indicate/configure the second PDCCH monitoring operation for the Type0/0A/1/2-CSS to/for the UE by selecting at least one of [Method 1-1] to [Method 1-3].

The corresponding indication/configuration is not fixed and may be individually configured for the UE according to various conditions such as a UE, a BWP, a subcarrier spacing (SCS), and a cell through a higher layer parameter (e.g., RRC layer). For example, if the operation of [Method 1-2] is configured for a specific UE, whether the UE always performs second PDCCH monitoring for the Type0/0A/1/2-CSS in a C-DRX situation may be determined according to whether first PDCCH of the corresponding CSS is performed. If [Method 1-2] is configured for each BWP, the UE always performs second PDCCH monitoring for the Type0/0A/1/2-CSS in BWP #1 like the existing NR UE, but, in BWP #2, the UE may perform second PDCCH monitoring in a corresponding CSS depending on whether first PDCCH monitoring is performed in the CSS.

Meanwhile, as described above, it may be configured for the UE through a higher layer parameter (e.g., RRC layer) that a plurality of methods among [Method 1-1] to [Method 1-3] may be used, and one of the plurality of methods may be indicated through DCI or a MAC CE, so that the UE may perform second PDCCH monitoring based on the indicated method.

According to [Method 1-1] to [Method 1-3], power consumption due to PDCCH monitoring may be reduced by skipping the C-RNTI monitoring operation in the Type0/0A/1/2-CSS or reducing the number of times of the C-RNTI monitoring operation in the Type0/0A/1/2-CSS.

[Method 2] P-RNTI monitoring for the Type2-PDCCH CSS set based on PDCCH monitoring adaptation indicated to the UE may not be performed.

[Method 1] has proposed the operation of the UE that enables the UE to always perform monitoring without being affected by a PDCCH monitoring adaptation indication in the same manner as the existing Rel-16 NR UE.

In contrast, in [Method 2], first PDCCH monitoring (i.e., P-RNTI monitoring) for the Type2-CSS may be configured to be included in the PDCCH monitoring operation differently from the operation of the UE proposed in [Method 1]. For example, SI-RNTI, RA-RNTI, MsgB-RNTI, and/or P-RNTI monitoring for the Type0/0A/1/2-CSS is performed according to [Method 1-1], and C-RNTI monitoring for the Type0/0A/1/2-CSS is not performed. If PDCCH monitoring adaptation for the operation of [Method 2] is indicated to the UE, SI-RNTI, RA-RNTI and/or MsgB-RNTI monitoring for the Type0/0A/1-CSS may be performed, and C-RNTI monitoring for the Type0/0A/1/2-CSS and P-RNTI monitoring for the Type2-CSS may not be performed.

When [Method 1-2] or [Method 1-3] is configured, the UE performs the PDCCH monitoring adaptation operation according to [Method 1-2] or [Method 1-3]. If PDCCH monitoring adaptation for the operation of [Method 2] is indicated to the UE, P-RNTI monitoring for the Type2-CSS may be excluded from a target for PDCCH monitoring.

Alternatively, if there is no configuration for the operation of [Method 1], the UE performs SI-RNTI, RA-RNTI, MsgB-RNTI, P-RNTI, and/or C-RNTI monitoring for the Type0/0A/1/2-CSS. If PDCCH monitoring adaptation for the operation of [Method 2] is indicated to the UE, P-RNTI monitoring for the Type2-CSS may not be performed, and SI-RNTI, RA-RNTI, MsgB-RNTI, and/or C-RNTI monitoring for the Type0/0A/1/2-CSS may be performed.

The operation in which the UE in an RRC_CONNECTED state performs first PDCCH monitoring for the Type2-CSS is described in Table 5 below, extracted from 3GPP TS 38.331.

TABLE 5
The modification period boundaries are defined by SFN values for which SFN mod m = 0,
where m is the number of radio frames comprising the modification period. The
modification period is configured by system information.
...
UEs in RRC_CONNECTED shall monitor for SI change indication in any paging
occasion at least once per modification period if the UE is provided with common search
space, including pagingSearchSpace, searchSpaceSIB1 and
searchSpaceOtherSystemInformation, on the active BWP to monitor paging,
...
ETWS or CMAS capable UEs in RRC_CONNECTED shall monitor for indication about
PWS notification in any paging occasion at least once every defaultPagingCycle if the UE
is provided with common search space, including pagingSearchSpace, searchSpaceSIB1
and searchSpaceOtherSystemInformation, on the active BWP to monitor paging.
...

A modification period of the standard document is described in Table 6 below, extracted from 3GPP TS 38.331. Table 6 is a collection of information about the modification period in 3GPP TS 38.331 in order to easily understand the description of the modification period.

TABLE 6

| | |
|---|---|
| BCCH-Config ::= | SEQUENCE { |
| modificationPeriodCoeff | ENUMERATED {n2, n4, n8, n16}, |

modificationPeriodCoeff
Actual modification period, expressed in number of radio frames m =
modificationPeriodCoeff* defaultPagingCycle, see clause 5.2.2.2.2. n2 corresponds to value
2, n4 corresponds to value 4, and so on.

| | |
|---|---|
| PCCH-Config ::= | SEQUENCE { |
| defaultPagingCycle | PagingCycle, |
| PagingCycle ::= | ENUMERATED {rf32, rf64, rf128, rf256} |

The UE is defined to page a system information (SI) change indication in one or more paging occasions (POs) per modification period and to page a public warning system (PWS) notification in one or more POs per defaultPagingCycle.

In other words, since the UE should perform paging at a certain period, P-RNTI monitoring of the Type2-CSS may be configured to be affected by PDCCH monitoring adaptation differently from the Type0/0A/1-CSS, which is monitored only in a specific situation. Referring to Table 6, defaultPagingCycle is configured to be a multiple of at least 32 wireless frame units, and the modification period is configured to be a multiple of at least 64 wireless frame units.

Considering that a duration of PDCCH monitoring skipping or SSSG switching that may be indicated to the UE is a symbol or slot unit, paging is performed in one or more POs based on a time unit longer than a PDCCH monitoring adaptation duration that may be indicated. Therefore, the BS may indicate the UE that P-RNTI monitoring for the Type2-CSS does not need to be temporarily performed during the PDCCH monitoring adaptation duration.

In other words, [Method 2] proposes an operation in which the UE does not perform P-RNTI monitoring for the Type2-PDCCH CSS set when the UE is indicated to perform PDCCH monitoring adaptation based on [Method 2]. For example, PDCCH monitoring adaptation indicated in [Method 2] may be PDCCH monitoring skipping, which does not monitor all PDCCHs, or SSSG switching to an SSSG, which does not include the Type2-CSS. For this purpose, similar to [Method 1-1] and [Method 1-2], the Type2-CSS may be configured not to be included in any SSSG or may be configured to be included in one or more SSSGs.

If SSSG switching indicating monitoring for a specific SSSG is indicated, or an SSSG that the UE is currently monitoring is a specific SSSG and the Type2-CSS is not included in the specific SSSG, the UE may not perform P-RNTI monitoring for the Type2-CSS. In this case, second PDCCH monitoring may follow [Method 1-1] or [Method 1-2], or it may be necessary to explicitly indicate that second PDCCH monitoring is performed by the UE in the same manner as performed by the existing NR UE.

The operation of the UE for the Type0/0A/1-CSS may be the same as the existing NR operation. Alternatively, if [Method 1-1] or [Method 1-2] is configured, the operation of [Method 1-1] or [Method 1-2], except for P-RNTI monitoring for the Type2-CSS, is performed. That is, while first PDCCH monitoring for the Type0/0A/1-CSS may be performed in the same manner as performed by the existing NR UE, first PDCCH monitoring for the Type2-CSS may follow the operation of [Method 2], and second PDCCH monitoring for the Type0/0A/1/2-CSS may follow the operation of [Method 1-1] or [Method 1-2].

As described above, the UE performs paging one or more times per period at a period of a long time unit. Therefore, even if paging is not performed during a PDCCH monitoring adaptation duration, which is a relatively short time within a period of a long time unit, the overall operation of the UE may not be affected.

However, the UE has not yet performed paging within a modification period with a very low probability, and monitoring adaptation of a duration including all POs within the modification period may be indicated.

In this case, a problem may arise in which the UE fails to perform paging within the modification period. To solve this problem, if the UE operation of [Method 2] is configured, and PDCCH monitoring adaptation for a duration including all POs within the modification period (e.g., PDCCH monitoring skipping for skipping PDCCH monitoring in the corresponding duration or SSSG switching to an SSSG that does not include the Type2-CSS in the corresponding duration) is indicated although the UE has not yet performed paging, the UE may perform paging at a PO that is foremost in time within the indicated PDCCH monitoring adaptation duration. Alternatively, the UE may be configured to perform paging at a PO that is latest in time. These operations may be configured fixedly or may be preconfigured in a higher layer and separately indicated through DCI.

Due to application delay, if there is a difference corresponding to a certain duration between an actual PDCCH monitoring adaptation indicated time and a DCI reception time, and there is more than one PO within the certain duration, the UE may perform paging through a PO within the certain duration.

Alternatively, in order to completely guarantee a PDCCH monitoring adaptation duration, the UE may perform paging at the earliest PO (or a specific n-th PO from the earliest PO) after indicated PDCCH monitoring adaptation ends. In other words, the BS may ensure that the UE performs paging before a certain time after PDCCH monitoring adaptation is completed.

Through [Method 2], the BS may guarantee a time during which the UE does not have to perform paging, which should be performed more than once per period, to ensure a time for the UE to sleep. Thereby, power saving gain may be expected.

[Method 3] The UE may monitor PDCCH candidates and non-overlapped CCEs by temporarily prioritizing a USS over a CSS within a DRX active time.

In the existing NR system, the maximum number of times of PDCCH monitoring and the number of channel measurements during one slot or span of the UE are determined as specific values. The maximum number of times of PDCCH monitoring per slot of the UE refers to the maximum number of monitoring PDCCH candidates per slot, which is defined in the standard document 3GPP TS 38.213 as shown in Table 7 below.

TABLE 7

| | Maximum number of monitored PDCCH |
|---|---|
| | candidates per slot and per serving |
| μ | cell M_{PDCCH}^{max,slot,u} |
| 0 | 44 |
| 1 | 36 |
| 2 | 22 |
| 3 | 20 |

The maximum number of channel measurements per slot of the UE refers to the maximum number of non-overlapped CCEs per slot, which is defined in the standard document 3GPP TS 38.213 as shown in Table 8 below.

TABLE 8

| | Maximum number of non-overlapped |
|---|---|
| | CCEs per slot and per serving cell |
| μ | C_{PDCCH}^{max,slot,u} |
| 0 | 56 |
| 1 | 56 |
| 2 | 48 |
| 3 | 32 |

In the present disclosure, limits on the number of times of PDCCH monitoring and the number of channel measurements per slot of the UE as shown in Table 7 and Table 8 are collectively referred to as a BD/CCE limit. In other words, the BD/CCE limit means both the maximum number of monitoring PDCCH candidates per slot and the number of non-overlapped CCEs per slot.

The operation of the NR standard UE for the above-mentioned BD/CCE limit is as shown in Table 9 extracted from the standard document 3GPP TS 38.213.

TABLE 9
Denote by V_{CCE} (Sᵤₛₛ (j)) the set of non-overlapping CCEs for search space set Sᵤₛₛ (j) and
by [symbol] (V_{CCE} (Sᵤₛₛ (j))) the cardinality of V_{CCE} (Sᵤₛₛ (j)) where the non-overlapping CCEs for
search space set Sᵤₛₛ (j) are determined considering the allocated PDCCH candidates for
monitoring for the CSS sets and the allocated PDCCH candidates for monitoring for all
search space sets Sᵤₛₛ (k), O ≤ k ≤ j.
Set M_{PDCCH}^{uss} = min(M_{PDCCH}^{max,slot,μ}, M_{PDCCH}^{total,stot,μ}) − M_{PDCCH}^{css}
Set C_{PDCCH}^{uss} = min(C_{PDCCH}^{max,slot,μ}, C_{PDCCH}^{total,stot,μ}) − C_{PDCCH}^{css}
Set j = 0
while
${\sum }_{L} {M}_{{S}_{uss} ( j )}^{( L )} \leq {M}_{PDCCH}^{u s s} AND 𝒞 ( {V}_{CCE} ( {S}_{u s s} ( j ) ) ) \leq {C}_{P D C C H}^{u s s}$
allocate
${\sum }_{L} {M}_{{S}_{uss} ( j )}^{( L )}$
PDCCH candidates for monitoring to USS set Sᵤₛₛ (j)
${M}_{P D C C H}^{u s s} = {M}_{P D C C H}^{u s s} - {\sum }_{L} {M}_{{S}_{uss} ( j )}^{( L )} ;$
C_{PDCCH}^{uss} = C_{PDCCH}^{uss} − [symbol] (V_{CCE} (S_{USS} (j)));
j = j + 1 ;
end while

Referring to Table 9, the UE may preferentially monitor a CSS and monitor a USS in order of an SS set ID using the remaining BD/CCE limit. While the C-DRX UE is monitoring SSSG #1 for sparse monitoring to save power, a lot of data is expected to be transmitted, and thus the BS may instruct the UE to perform SSSG switching to monitor SSSG #0 for dense monitoring.

In this case, the BS may indicate data scheduling information by transmitting non-fallback DCI for scheduling to the UE through the USS. However, there are many MOs for the CSS such as the Type0/0A/1/2-CSS in a slot of the USS that may receive the scheduling information with a low probability, and as the UE performs first PDCCH monitoring and second PDCCH monitoring for the CSS, the UE may fail to receive the non-fallback DCI that the BS intends to transmit through the USS due to the BD/CCE limit.

To prevent the above-mentioned problem, [Method 3] proposes an operation in which the UE temporarily prioritizes the USS over the CSS to monitor PDCCH candidates and non-overlapped CCEs. In other words, in [Method 3], the USS takes priority over the CSS only during some durations in an application order of the BD/CCE limit. That is, the UE performing [Method 3] may monitor the PDCCH candidates and the non-overlapped CCEs for the USS within one slot and starts to monitor the CSS after monitoring for all USSs is completed. In this case, the monitoring order of the CSS may be from Type0 to Type3 of the CSS. Alternatively, Type3 may be prioritized and then Type0, Type1, and Type2 may be sequentially monitored.

The BS may indicate/configure the operation of [Method 3] to/for the UE. For example, the BS may previously indicate/configure the operation of [Method 3] through a higher layer parameter or indicate the operation of [Method 3] through DCI. Additionally, the operation of [Method 3] may be fixed. For example, [Method 3] may be applied in a specific slot or specific span.

For example, the operation of the UE according to [Method 3] may be performed according to at least one of examples below.

1) When PDCCH monitoring adaptation is indicated, the UE may perform the operation according to [Method 3] in all or part of a duration for which PDCCH monitoring adaptation is indicated. Meanwhile, when [Method 3] is applied to a portion of the indicated duration, [Method 3] may be applied in a specific ratio of the indicated duration or in units of fixed symbols, slots, or ms.

2) The UE may perform the operation according to [Method 3] throughout a configured DRX active time.

3) The UE may perform the operation according to [Method 3] in a first partial duration of the configured DRX active time (e.g., 10 slots).

When [Method 3] is configured and the UE applies the BD/CCE limit by prioritizing the USS over the CSS during a corresponding duration, the indicated duration may not match a slot boundary. In this case, the operation of the UE that prioritizes the USS over the CSS may be configured to be applied up to a boundary between a slot including the last symbol of the indicated duration and the next slot.

Alternatively, the operation of the existing NR UE of prioritizing the USS until the last symbol of the indicated duration and prioritizing the CSS from a symbol immediately after the last symbol of the indicated duration may be performed. For example, when applying the BD/CCE limit within one slot, the USS may be applied with priority up to a specific symbol, and the CSS may be applied with priority after the specific symbol.

Even though the UE operates as described above, if the UE has already monitored the USS with priority over the CSS within one slot, an effect that has been expected through [Method 3] may be considered to be achieved.

[Method 3] may be applied to all general PDCCH monitoring adaptation situations or limited to specific PDCCH monitoring adaptation. For example, [Method 3] may be limited to SSSG switching from SSSG #1 for sparse monitoring purposes to SSSG #0 for dense monitoring purposes. In other words, the operation of [Method 3] may be performed in SSSG switching from SSSG #1 to SSSG #0, and the operation of [Method 3] may not be performed when SSSG switching to SSSG #1 from SSSG #0 is indicated or PDCCH monitoring skipping is indicated.

Conventionally, since the CSS had to be monitored unconditionally before the USS. In order for the BS to transmit DCI through the USS, since the UE had to perform PDCCH monitoring as many times as the number of CSSs allocated to at least one slot, load due to PDCCH monitoring of the UE could be large. However, according to [Method 3], if the BS desires to transmit the DCI through the USS in a situation in which the BS does not use the CSS or desires to use the CSS less frequently, the monitoring priority of the USS may be configured to be higher than that of the CSS, and thus the UE performs PDCCH monitoring starting from the USS. Therefore, the load due to PDCCH monitoring of the UE may be reduced.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

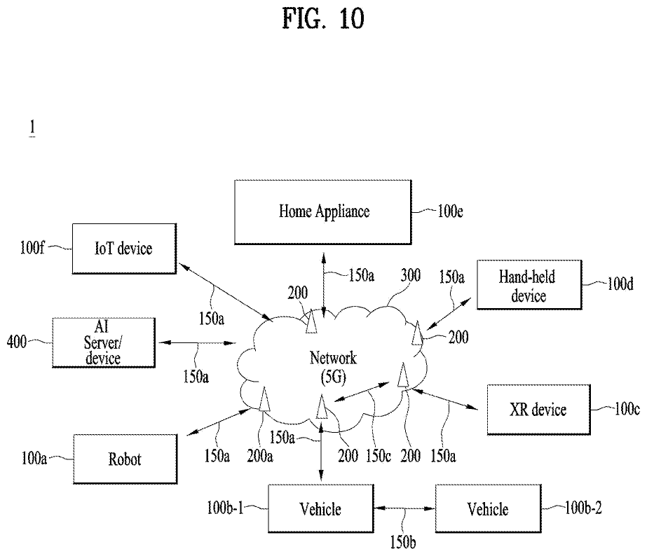

FIG. 10 illustrates a communication system 1 applied to the present disclosure.

Referring to FIG. 10, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

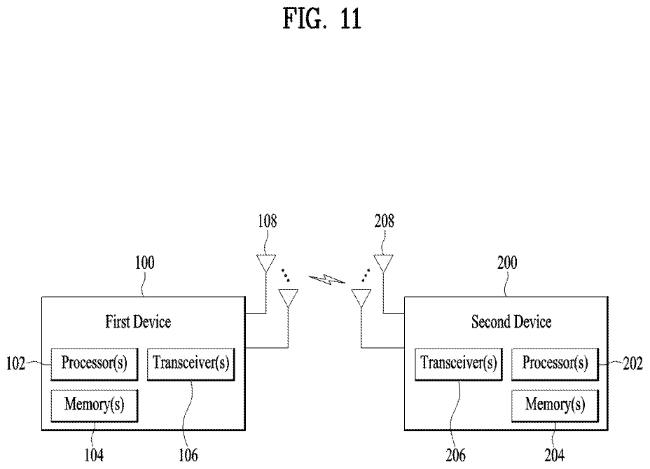

FIG. 11 illustrates wireless devices applicable to the present disclosure.

Referring to FIG. 11, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 10.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor(s) 102 of the first wireless device 100 and stored in the memory(s) 104 of the first wireless device 100, according to an embodiment of the present disclosure will now be described.

Although the following operations will be described based on a control operation of the processor(s) 102 in terms of the processor(s) 102, software code for performing such an operation may be stored in the memory 104. For example, in the present disclosure, the at least one memory(s) 104 may store instructions or programs as a computer-readable storage medium. The instructions or the programs may cause, when executed, at least one processor operably connected to the at least one memory to perform operations according to embodiments or implementations of the present disclosure, related to the following operations.

For example, the processor(s) 102 may receive an RRC parameter related to PDCCH monitoring adaptation through the transceiver(s) 106 (S701). For example, information included in the RRC parameter may be based on at least one of [Method 1] to [Method 3] described above.

The processor(s) 102 may receive information related to PDCCH monitoring adaptation for a CSS set through the transceiver(s) 106. For example, the processor(s) 102 may receive the information through a MAC-CE or DCI through the transceiver(s) 106.

The processor(s) 102 may monitor a PDCCH through the CSS set and/or a USS set based on the received information and receive the PDCCH through the transceiver(s) 106. For example, the processor 102 may receive the corresponding information through the transceiver(s) 106 and perform monitoring and reception of the PDCCH, based on at least one of [Method 1] to [Method 3] described above.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 200 and stored in the memory 204 of the second wireless device 200, according to an embodiment of the present disclosure will now be described.

Although the following operations will be described based on a control operation of the processor 202 in terms of the processor 202, software code for performing such an operation may be stored in the memory 204. For example, in the present disclosure, the at least one memory 204 may store instructions or programs as a computer-readable storage medium. The instructions or the programs may cause, when executed, at least one processor operably connected to the at least one memory to perform operations according to embodiments or implementations of the present disclosure, related to the following operations.

For example, the processor(s) 202 may transmit an RRC parameter related to PDCCH monitoring adaptation through the transceiver(s) 206. For example, information included in the RRC parameter may be based on at least one of [Method 1] to [Method 3] described above.

The processor(s) 202 may transmit information related to PDCCH monitoring adaptation for a CSS set through the transceiver(s) 206. For example, the processor(s) 202 may transmit the information through a MAC-CE or DCI through the transceiver(s) 206.

The processor(s) 202 may transmit a PDCCH through the CSS set and/or a USS set based on the transmitted information and transmit the PDCCH through the transceiver(s) 206. For example, the processor 202 may transmit the corresponding information and the PDCCH through the transceiver(s) 206 based on at least one of [Method 1] to [Method 3] described above.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

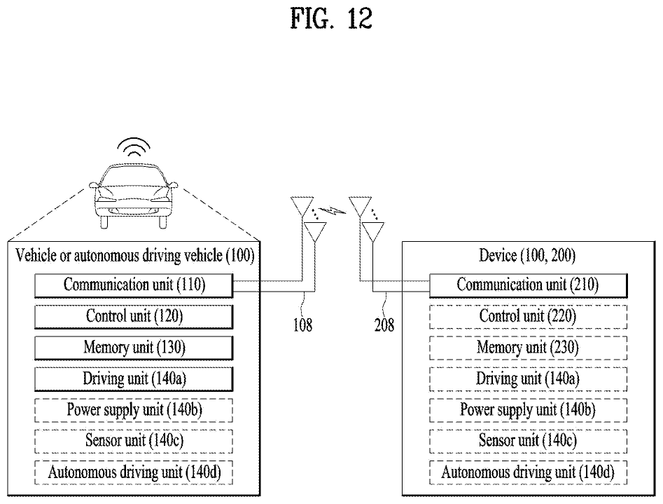

FIG. 12 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 12 a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

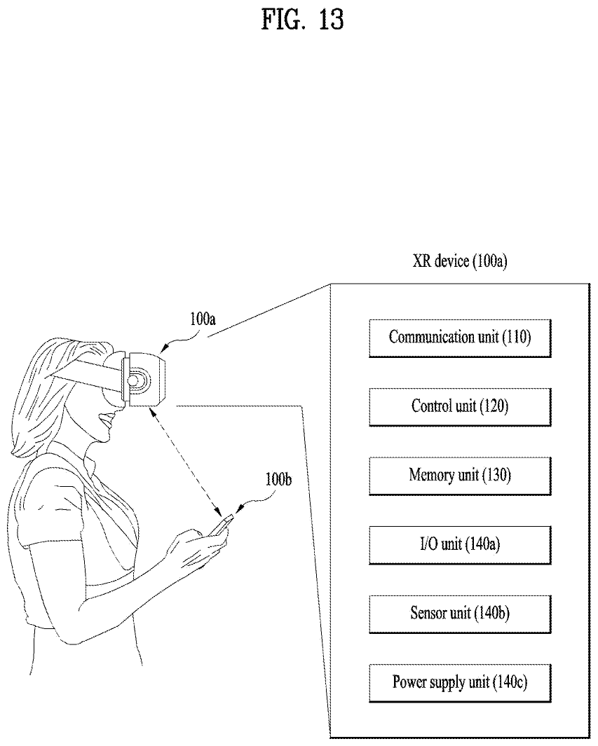

FIG. 13 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 13, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

While the above-described method of transmitting and receiving a signal in an unlicensed band and an apparatus therefor have been described based on an example applied to a 5G NR system. the method and apparatus are applicable to various wireless communication systems in addition to the 5G NR system.

1. A method of receiving a physical downlink control channel (PDCCH) by a user equipment (UE) in a wireless communication system, the method comprising:
receiving a parameter related to PDCCH monitoring adaptation through a higher layer signaling:
receiving information regarding an operation related to the PDCCH monitoring adaptation based on the parameter; and
receiving the PDCCH based on the information,
wherein the receiving the PDCCH includes monitoring the PDCCH through a common search space (CSS) set based on a radio network temporary identifier (RNTI) different from a cell-RNTI (C-RNTI) during a time duration related to the information.

2. The method of claim 1, further comprising:
monitoring the PDCCH through the CSS set based on the C-RNTI, based on reception of the PDCCH through the CSS set based on the RNTI.

3. The method of claim 1, further comprising:
receiving information related to a time for monitoring the PDCCH based on the C-RNTI; and
monitoring the PDCCH based on the C-RNTI through the CSS set based on the information related to the time.

4. The method of claim 1, further comprising:
monitoring the PDCCH based on the C-RNTI for a type of a CSS set included in a specific search space (SS) set, based on the PDCCH monitoring adaptation being related to SS set switching regarding switching to the specific SS set.

5. The method of claim 1, wherein the CSS set has a type different from Type 2.

6. The method of claim 1, wherein the PDCCH is monitored by prioritizing a UE-specific search space (USS) over a CSS during the time duration.

7. The method of claim 1, wherein the CSS set has a type different from Type 3.

8. A user equipment (UE) for receiving a physical downlink control channel (PDCCH) in a wireless communication system, the UE comprising:
at least one transceiver;
at least one processor; and
at least one memory operably connectable to the at least one processor and configured to store instructions that, when executed, cause the at least one processor to perform operations,
wherein the operations comprise:
receiving, through the at least one transceiver, a parameter related to PDCCH monitoring adaptation through a higher layer signaling;
receiving, through the at least one transceiver, information regarding an operation related to the PDCCH monitoring adaptation based on the parameter; and
receiving, through the at least one transceiver, the PDCCH based on the information, and
wherein the receiving the PDCCH includes monitoring the PDCCH through a common search space (CSS) set based on a radio network temporary identifier (RNTI) different from a cell-RNTI (C-RNTI) during a time duration related to the information.

9. The UE of claim 8, wherein the operations further comprises;
monitoring the PDCCH through the CSS set based on the C-RNTI, based on reception of the PDCCH through the CSS set based on the RNTI.

10. The UE of claim 8, wherein the operations further comprise:
receiving information related to a time for monitoring the PDCCH based on the C-RNTI; and
monitoring the PDCCH based on the C-RNTI through the CSS set based on the information related to the time.

11. The UE of claim 8, wherein the operations further comprise:
monitoring the PDCCH based on the C-RNTI for a type of a CSS set included in a specific search space (SS) set, based on the PDCCH monitoring adaptation being related to SS set switching regarding switching to the specific SS set.

12. The UE of claim 8, wherein the CSS set has a type different from Type 2.

13. The UE of claim 8, wherein the PDCCH is monitored by prioritizing a UE-specific search space (USS) over a CSS during the time duration.

14. The method of claim 8, wherein the CSS set has a type different from Type 3.

15-17. (canceled)

18. A base station (BS) for transmitting a physical downlink control channel (PDCCH) in a wireless communication system, the BS comprising:
at least one transceiver;
at least one processor; and
at least one memory operably connectable to the at least one processor and configured to store instructions that, when executed, cause the at least one processor to perform operations,
wherein the operations comprise:
transmitting, through the at least one transceiver, a parameter related to PDCCH monitoring adaptation through a higher layer signaling;
transmitting, through the at least one transceiver, information regarding an operation related to the PDCCH monitoring adaptation based on the parameter; and
transmitting, through the at least one transceiver, the PDCCH through a common search space (CSS) set based on a radio network temporary identifier (RNTI) different from a cell-RNTI (C-RNTI) during a time duration related to the information.
